(19) United States
(12) Patent Application Publication
(10) Pub. No.: US 2007/0283562 A1
(43) Pub. Date: Dec. 13, 2007

(54) Method for making a non-driving vehicle axle beam

(75) Inventors: Kenneth A. Weise, Lake Orion, MI (US); Bryan M. Lach, South Lyon, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Benteler Automotive Corporation

(21) Appl. No.: 11/455,294

(22) Filed: Jun. 5, 2006

(51) Int. Cl. B21D 53/88; B23P 11/00; B23P 17/00

(52) U.S. Cl. 29/897.2; 29/421.1; 29/525.14

(57) ABSTRACT

A method for making a non-driving vehicle axle beam includes selecting a straight section of elongate tube of hardenable steel. The tube is cut to length, and positioned in a die cavity which corresponds to the shape of the finished axle beam. Pressurized fluid is communicated with the interior of the tube to inelastically deform the same into conformance with the shape of the die cavity. The formed tube is removed from the die and selectively heat treated at the areas of high stress during use to define the finished axle beam.

### BACKGROUND OF THE INVENTION

The present invention relates to vehicles, and in particular to a method for making non-driving vehicle axle beams and the like.

Vehicle axle beams are well known in the art. Rigid axle beams are typically forged, and are generally best suited for non-driving applications, wherein the wheels that are connected to the ends of the rigid axle beam are not rotatably driven by the engine of the vehicle. Hence, non-driving axle beams are commonly used as front axle beams in rear wheel drive vehicles, and as rear axle beams in front wheel drive vehicles.

Non-driving vehicle axle beams are subjected to substantial stress during use, which tends to concentrate in certain areas of the axle beam. Hence, axle beams must be both strong and rigid to resist such forces. While many prior art axle beams provide adequate strength and rigidity for most applications, they tend to be rather bulky and heavy, thereby sacrificing fuel efficiency and space economy. Hence, an axle beam that is strong, rigid, compact, light-weight, and capable of being manufactured in a cost effective manner would be clearly beneficial.

### SUMMARY OF THE INVENTION

One aspect of the present invention is a method for making a non-driving vehicle axle beam having selected areas of high stress during use. The method includes selecting an elongate tube constructed of hardenable steel, and having a generally straight shape and a sidewall with a non-uniform thickness defining areas of increased thickness at the areas of high stress during use. The tube is cut to a predetermined length in accordance with the length and shape of the finished axle beam. The cut tube is positioned in a die having cooperating die sections that define a cavity with a shape which corresponds to the shape of the finished axle beam. Pressurized fluid is communicated with the interior of the cut tube mounted in the die, thereby inelastically deforming the cut tube under the force of the pressurized fluid into conformance with the shape of the die cavity. The formed tube is removed from the die, and selectively heat treated at the areas of high stress during use to define the finished axle beam.

Yet another aspect of the present invention is a method for making a non-driving vehicle axle beam having selected areas of high stress during use, comprising providing an elongate tube constructed of hardenable steel, and having a generally straight shape. The tube is cut to a predetermined length in accordance with the length and shape of the finished axle beam. The cut tube is positioned in a die having cooperating die sections that define a cavity with a shape which corresponds to the shape of the finished axle beam. Pressurized fluid is communicated with the interior of the cut tube mounted in the die, thereby inelastically deforming the cut tube under the force of the pressurized fluid into conformance with the shape of the die cavity. The cut tube is removed from the die, and selectively heat treated at the areas of high stress during use to define the finished axle beam.

Yet another aspect of the present invention is to provide a method for making a strong, rigid, compact and light-weight non-driving vehicle axle beam in a cost effective manner, which focuses material and strength at the high stress areas where it is needed most.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of a non-driving vehicle axle beam made in accordance with the present invention.

FIG. 2 is a top plan view of the vehicle axle beam.

FIG. 3 is a vertical cross-sectional view of the vehicle axle beam taken along the line III-III, FIG. 2.

FIG. 4 is a vertical cross-sectional view of the vehicle axle beam taken along the line IV-IV, FIG. 4.

FIG. 5 is a vertical cross-sectional view of the vehicle axle beam taken along the line V-V, FIG. 5.

FIG. 6 is a vertical cross-sectional view of another embodiment of the present invention, taken along an outboard side thereof.

FIG. 7 is a vertical cross-sectional view of the vehicle axle beam shown in FIG. 6, taken along an intermediate area of high stress during use.

FIG. 8 is a vertical cross-sectional view of the vehicle axle beam shown in FIGS. 6 and 7, taken along a medial portion thereof.

FIG. 9 is a flow chart illustrating various steps of the method embodying the present invention.

### DETAILED DESCRIPTION OF THE PREFERRED EMBODIMENTS

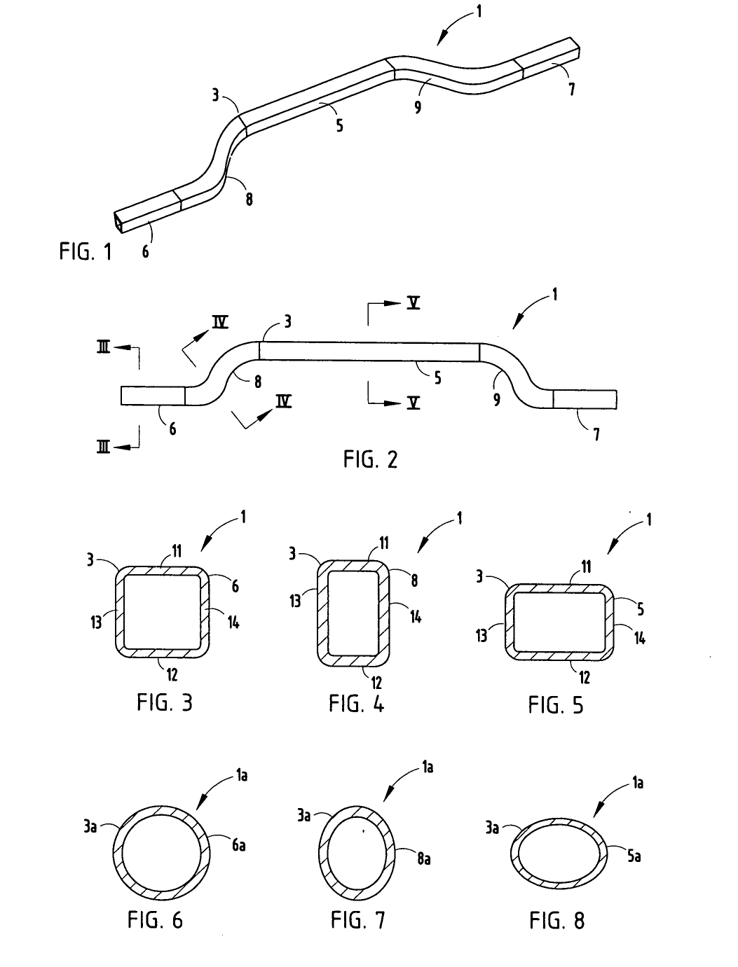

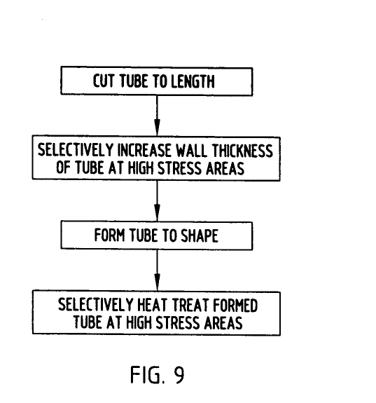

For purposes of description herein, the terms “upper”, “lower”, “right”, “left”, “rear”, “front”, “vertical”, “horizontal” and derivatives thereof shall relate to the invention as oriented in FIG. 1, and installed in an associated vehicle. However, it is to be understood that the invention may assume various alternative orientations and step sequences, except where expressly specified to the contrary. It is also to be understood that the specific devices and process illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 1 (FIGS. 1-5) generally designates a non-driving vehicle axle beam embodying the present invention. Vehicle axle beam 1 comprises an elongate tube 3 constructed of hardenable steel which is formed to shape and selectively heat treated at the areas of high stress during use.

The illustrated vehicle axle beam 1 has a generally U-shaped plan configuration defined by a generally straight center portion 5, a pair of generally straight outer portions 6 and 7, and a pair of generally curved portions 8 and 9 interconnecting outer portions 6 and 7 with the opposite ends of center portion 5.

In one working embodiment of the present invention, as illustrated in FIGS. 1-5, the outer portions 6 and 7 of vehicle axle beam 1 have a generally square vertical cross-sectional shape (FIG. 3) defined by an integral top wall 11, a bottom wall 12 and sidewalls 13 and 14, which have a generally uniform wall thickness in the range of 2.5-3.5 millimeters, such as around 3.3 millimeters. As is apparent to those having ordinary skill in the art, the wall thickness of tube walls 11-14 will vary in accordance with the specific application.

The curved portions 8 and 9 of vehicle axle beam 1 are areas of high stress during use, and have a generally rectangular vertical cross-sectional shape, as shown in FIG. 4. In the example illustrated in FIG. 4, the walls 11-14 of the tube have been inelastically deformed so that sidewalls 13 and 14 are longer than the corresponding sidewalls of the outer portions 6 and 7, and the top and bottom walls 11 and 12 of curved portions 8 and 9 are somewhat shorter than the corresponding top and bottom walls of outer portions 6 and 7. The thickness of the walls 11-14 at the curved portions 8 and 9 is generally uniform, and in the illustrated example, has a thickness in the range of 5.0-6.0 millimeters, such as around 5.5 millimeters. As is apparent to those having ordinary skill in the art, the wall thickness of the tube walls 11-14 will vary in accordance with the specific application. It is noteworthy that, in the embodiment illustrated in FIGS. 1-5, the wall thickness of the curved portions 8 and 9 is greater than the wall thickness of the outer portions 6 and 7 and center portion 5, so as to provide greater strength and rigidity to vehicle axle beam 1 at the areas of high stress during use.

With reference to FIG. 5, the center portion 5 of the illustrated vehicle axle beam 1 has a generally rectangular shape. In the example shown in FIG. 5, the top and bottom walls 11 and 12 of center portion 5 are longer than the top and bottom walls of outer portions 6 and 7, and the sidewalls 13 and 14 of center portion 5 are somewhat shorter than the sidewalls 13 and 14 of outer portions 6 and 7. The walls 11-14 of center portion 5 have a generally uniform thickness in the range of around 2.5-3.5 millimeters, such as around 3.3 millimeters. As is apparent to those having ordinary skill in the art, the wall thickness of the tube walls 11-14 will vary in accordance with the specific application.

The vehicle axle beam 1 illustrated in FIGS. 1-5 may be manufactured in accordance with the following method. An elongate tube constructed of hardenable steel is selected, having a generally straight shape and a sidewall with a non-uniform thickness defining areas of increased thickness at the areas of high stress during use, as shown in FIGS. 4 and 7. In one working embodiment of the present invention, the selected elongate tube is constructed from a steel such as that known in the trade as BTR165 (DB200) and/or BAS100. The selected tube is cut to a predetermined length in accordance with the length and shape of the desired finished axle beam. The cut tube is positioned in a die having cooperating die sections that define a cavity with a shape which corresponds to the shape of the finished axle beam. Pressurized fluid is communicated with the interior of the cut tube mounted in the die, thereby inelastically deforming the cut tube under the force of the pressurized fluid into conformance with the shape of the die cavity. The cut tube is removed from the die to define a formed axle beam, which is in turn selectively heat treated at the areas of high stress during use to define the finished axle beam. The selective post form heat treatment of tube 3 may be accomplished with induction heating or the like, and serves to locally increase yield strength, which permits the use of thinner tubes for similar applications, so as to reduce material cost, and also improve vehicle dynamics, including ride and handling, by reducing unsprung mass.

In at least one embodiment of the present invention, the die cavity is shaped to alter the lateral cross-sectional shape of the cut tube, particularly at the areas of high stress during use to selectively work harden the sidewalls of the cut tube at these areas, as illustrated in FIGS. 3-8. It is to be understood that the vehicle axle beam 1 can be formed using various hydroforming techniques, as well as crush forming, and other related processes.

The reference numeral 1a (FIGS. 6-8) generally designates another embodiment of the present invention having a generally round vertical cross-sectional shape. Since vehicle axle beam 1a is similar to the previously describe vehicle axle beam 1, similar parts appearing in FIGS. 1-5 and 6-8, respectively, are represented by the same, corresponding reference numerals, except for the suffix “a” in the numerals of the latter. In the example illustrated in FIG. 6, the outer portion 6a of vehicle axle beam 1a has a generally circular vertical cross-sectional shape. The curved portion 8a of vehicle axle beam 1a has a generally ovate shape which is longer in the vertical direction, while the center portion 5a has a generally ovate shape which is longer in the horizontal direction.

As will be appreciated by those having ordinary skill in the art, the specific shape, size and thickness of the vehicle axle beam 1, 1a may be varied to accommodate a wide variety of different applications. Also, the degree and specific location of the heat treatment and increased wall thickness are preferably focused at the areas of high stress during use where they are most needed.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is as follows:

1. A method for making a non-driving vehicle axle beam having selected areas of high stress during use, comprising:
selecting an elongate tube constructed of hardenable steel, and having a generally straight shape and a sidewall with a non-uniform thickness defining areas of increased thickness at the areas of high stress during use;
cutting the tube to a predetermined length in accordance with the length and shape of the finished axle beam;
positioning the cut tube in a die having cooperating die sections that define a cavity with a shape which corresponds to the shape of the finished axle beam;
communicating pressurized fluid with the interior of the cut tube mounted in the die;
inelastically deforming the cut tube under the force of the pressurized fluid into conformance with the shape of the die cavity;
removing the cut tube from the die to define a formed axle beam; and
selectively heat treating the formed axle beam at the areas of high stress during use to define the finished axle beam.

2. A method as set forth in claim 1, wherein:
said deforming step comprises forming the cut tube into a generally U-shaped plan configuration defined by a generally straight center portion, a pair of generally straight outer portions, and a pair of generally curved portions interconnecting the outer portions with opposite ends of the center portion.

3. A method as set forth in claim 2, wherein:
said heat treating step includes selectively heat treating at least portions of the curved portions of the formed axle beam at the areas of high stress during use.

4. A method as set forth in claim 3, wherein:
said providing step includes-providing the elongate tube with a generally uniform, predetermined lateral cross-sectional shape; and
said deforming step includes altering the lateral cross-sectional shape of the cut tube at the areas of high stress during use to selectively work harden the sidewall of the cut tube at the areas of high stress during use.

5. A method as set forth in claim 4, wherein:
said providing step includes providing the elongate tube with a quadrilateral lateral cross-sectional shape to define the generally uniform, predetermined lateral cross-sectional shape.

6. A method as set forth in claim 5, wherein:
said providing step includes providing the elongate tube with a generally square cross-sectional shape to define the generally uniform, predetermined lateral cross-sectional shape.

7. A method as set forth in claim 6, wherein:
said deforming step includes altering the generally square lateral cross-sectional shape of the cut tube at the areas of high stress during use to a generally rectangular shape.

8. A method as set forth in claim 4, wherein:
said providing step includes providing the cut tube with a generally circular lateral cross-sectional shape to define the generally uniform, predetermined lateral cross-sectional shape.

9. A method as set forth in claim 8, wherein:
said deforming step includes altering the generally circular lateral cross-sectional shape of the cut tube at the areas of high stress during use to a generally oval shape.

10. A non-driving axle beam manufactured in accordance with the method set forth in claim 4.

11. A non-driving axle beam manufactured in accordance with the method set forth in claim 1.

12. A method for making a non-driving vehicle axle beam having selected areas of high stress during use, comprising:
providing an elongate tube constructed of hardenable steel, and having a generally straight shape;
cutting the tube to a predetermined length in accordance with the length and shape of the finished axle beam;
positioning the cut tube in a die having cooperating die sections that define a cavity with a shape which corresponds to the shape of the finished axle beam;
communicating pressurized fluid with the interior of the cut tube mounted in the die;
inelastically deforming the cut tube under the force of the pressurized fluid into conformance with the shape of the die cavity;
removing the cut tube from the die to define a formed axle beam; and
selectively heat treating the formed axle beam at the areas of high stress during use to define the finished axle beam.

13. A method as set forth in claim 12, wherein:
said deforming step comprises forming the cut tube into a generally U-shaped plan configuration defined by a generally straight center portion, a pair of generally straight outer portions, and a pair of generally curved portions interconnecting the outer portions with opposite ends of the center portion.

14. A method as set forth in claim 13, wherein:
said heat treating step includes selectively heat treating at least portions of the curved portions of the formed axle beam at the areas of high stress during use.

15. A non-driving axle beam manufactured in accordance with the method set forth in claim 14.
